(19) United States
(12) Patent Application Publication
(10) Pub. No.: US 2015/0127553 A1
(43) Pub. Date: May 7, 2015

(54) INTELLIGENT PAYMENT CARD AND A METHOD FOR PERFORMING SECURE TRANSACTIONS USING THE PAYMENT CARD

(71) Applicants: MOHAN SUNDARAM, (US); NEERAJ GUPTA, (US)

(72) Inventors: Mohan Sundaram, Bangalore (IN); Neeraj Gupta, Bangalore (IN)

(21) Appl. No.: 14/405,404

(22) PCT Filed: May 28, 2013
(86) PCT No.: PCT/IN2013/000340

§ 371 Date: Dec. 4, 2014

(30) Foreign Application Priority Data
Jun. 6, 2012 (IN) 2274/CHE/2012

(51) Int. Cl. G06Q 20/34; G06Q 30/02; G06Q 20/22; G06Q 20/40

(52) U.S. Cl. CPC G06Q 20/341; G06Q 20/40145; G06Q 20/3572; G06Q 20/3563; G06Q 30/0233; G06Q 30/0255; G06Q 20/3437; G06Q 20/227; G06Q 20/4012
USPC 705/72; 705/44; 705/14.33; 705/14.53

(57) ABSTRACT

An intelligent payment card and a method for performing a financial transaction using the payment card are disclosed. The payment card includes inter-alia a biometric sensor, an input module, and a display screen. The payment card is activated when a primary user successfully authenticates himself by the way of providing valid finger print(s) to the biometric sensor of the payment card. The payment card is removably embedded with criteria that dictate at least a maximum transaction amount, maximum number of transactions to be performed on the card and maximum threshold time for completing a transaction. The payment card also includes a processor unit which compares the authorization code input by the user with a unique identification number stored within the payment card, and upon successful authentication enables the user to perform desired financial transaction and also ensures that the removably embedded criteria are not violated during the financial transaction.

### CROSS REFERENCE TO RELATED APPLICATIONS

The present patent application claims the priority of the Indian Provisional Patent Application No. 2274/CHE/2012 filed on 6 Jun. 2012. This patent application is a U.S. National Phase Application under 35 USC. 371, of the PCT International Application No. PCT/IN2013/000340 filed on 28 May 2013, and titled “Intelligent Payment Card and a System for Making Secure Transactions using the Payment Card”,

### BACKGROUND

1. Technical Field

The embodiments herein generally relate to a payment systems and methods and particularly relates to a payment card for providing secure controlled and reliable transaction of finds. The embodiments herein more particularly relates to a method and system for eliminating payment card fraud when the card is presented for transactions.

2. Description of the Related Art

At the present time, bank or transaction type cards have gained wide acceptance throughout the world. Various transaction cards are used as an alternative to cash. In addition, transaction cards have been used to initiate and carry out 24-hour banking services and other automatic purchases as they are more often convenient than cash or cheques, and are almost universally accepted.

A vast majority of transaction cards consist of a rectangular plastic carrier having account information embossed thereupon. In addition, the carrier typically includes a magnetic stripe encoded with account information. The account information encoded on the magnetic snipe includes an account number, transaction identification number and even secret identifying code information. In some systems, the data on the card is encrypted to make counterfeiting more difficult.

The payment card fraud is a theft, fraud and forgery committed using a payment card or any similar payment mechanism as a fraudulent source of funds in a transaction. The payment card fraud is also an adjunct to identity theft. Because of increasing credit and fraud losses, various systems have been instituted to detect lost or stolen cards and to provide some form of authorization system for approving transactions.

In one of the current methods, a credit card fraud is minimized by decreasing a transaction time associated with the credit card purchases in the retail outlets.

The system of the prior art comprises a keypad and a display. The credit card user enters valid personal identification number (PIN) using the keypad. The received PIN is compared With the pre-stored PIN. If the received PIN matches with the stored PIN, the card is activated and credit account information is made available to the user using the output device. In this prior art, the user is authenticated in the backend server. Also, the credit card does not offer multi-users option. Also, this prior art does not prevent the card and PIN from being stolen and used for transactions.

Another prior art provides a system and a method for providing, a secure, controlled and reliable transaction of funds using the credit card. The system of the prior art includes a keypad for entering a personal identification number (PIN) and a display for displaying the transaction criteria. The electronic credit card is authenticated by entering a security authorization code, such as a PIN number into the keypad whereby the user verification module verifies that the PIN number is correct and thus the identity of the user is verified. Alternately, the electronic card is operational when a user is identified by a security authorization code in the form of a digital signature which is activated when a fingerprint of the user or an eyeball/retina scan of the user is recognized, or the security authorization code is generated from the fingerprint or eyeball/retina scan. In this prior art, the user is not facilitated to preview the performed number of the iterations, transactions etc.

In view of the foregoing, there is a need for a method and system which can overcome the above mentioned drawbacks by providing a payment card adapted to locally authenticate a user and activate the payment card. There is also a need for a method and system to determine the number of iterations performed by the user, to preset a maximum amount to be charged from the payment card and also to deactivate the payment card after a preset time period. There is a further need to secure the user's data from being read off or modified by the reader.

The above mentioned shortcomings, disadvantages and problems are addressed herein and which will be understood by reading and studying the following specification.

### OBJECTIVES OF THE EMBODIMENTS

The primary object of the embodiments herein is to provide an intelligent payment card for providing a secure financial transaction.

Another object of the embodiments herein is to provide a method and system to perform an authentication of the user locally within the payment card.

Yet another object of the embodiments herein is to provide a method and system for configuring the payment card for multi-users to provide access to the payment card for performing transactions.

Yet another object of the embodiments herein is to provide a method and system for providing a preset number of iterations in the payment card.

Yet another object of the embodiments herein is to provide a method and system to enable a preset maximum amount to be deducted from the payment card.

Yet another object of the embodiments herein is to provide a method and system to enable a secure transfer of data from the card to the payment processor without being compromised by the devices used for reading and intermediate hops to reach the payment processing servers.

Yet another object of the embodiments herein is to provide a method and system to enable the payment card to connect with external devices for configuration as well as charging the payment card.

Yet another object of the embodiments herein is to provide a method and system to enable the payment card to get deactivated automatically after a preset time period.

These and other objects and advantages of the embodiments herein will become apparent from the following detailed description read in conjunction with the accompanying drawings.

### SUMMARY

The various embodiments herein provide an intelligent payment card for providing secure financial transactions. The payment card comprises a biometric sensor for activating the payment card, an input module for inputting a plurality of transaction criteria on the payment card, a memory unit for storing the plurality of criteria for use in the financial transaction, a processor unit, a display screen to show the transaction logs and a communication module for communicating the transaction criteria to a transaction terminal to facilitate the financial transaction. The plurality of transaction criteria comprises a user account details, a unique authorization code, a preset amount of transaction, a preset number of transactions and a maximum threshold time for the transaction.

According to one embodiment herein, the biometric sensor is a fingerprint reader, wherein the fingerprint reader comprises an electronic chip for recording an extracted fingerprint template of the user, activating the payment card and authenticating the user. Alternatively, the biometric sensor can also be a voice sensor, retina/eyeball scanner and the like.

According to one embodiment herein, the input module is at-least one of a tactile keypad, a QWERTY keypad and a touch screen keypad and the communication module comprises at least one of a USB port, a Bluetooth, Infrared or Near Field communication.

According to one embodiment herein, the memory unit is adapted to record the number of transactions, a time stamp, an amount of transaction, payment terminal ID, a location of a transaction based on GPS and IP address and location of the payment terminal.

According to one embodiment herein, the power source for powering up the payment card is at least one of a dry cell, rechargeable battery and a photovoltaic source.

According to one embodiment herein, the payment card is one of a credit card, a debit card, a NFC card and an EMV card, which is tamperproof and is limited by geo-fencing.

According to one embodiment herein, the processor unit adapted to compare the input unique authorization code with a unique identification number stored within the payment card, authenticate the user, enable the user to initiate the financial transaction on successful authentication, enable a user to set preferences for the financial transaction, enable a user to configure multiple user accounts for the payment card and to set usage preferences for each user account, a display screen to show the transaction logs and a communication module for communicating the transaction criteria to a transaction terminal to facilitate the financial transaction.

According to one embodiment herein, the processor is further adapted to deactivate the payment card after a predetermined number of mismatches between the transaction code, the pre-stored transaction number, the preset number of transactions, the preset amount of transaction, deactivate the card after a predetermined time, charge the payment card with money, track the reward points of the card, display the reward point to the use and enables the user to redeem the reward points.

According to one embodiment herein, the payment card is configured by at least one of a user or a backend server.

Embodiments herein further provide a method for performing a secure financial transaction using a payment card. The method comprises of programming the payment card with a plurality of pre-set user information, verify the authenticity of the user, activating the payment card on successful authentication of the user, inputting an unique authorization code by the user, validating the user for the financial transaction by comparing the input unique authorization code with a unique identification number stored within the payment card, defining a maximum threshold of an amount be charged on the payment card successful validation and deducting the preset amount from the card at a retailer end. The plurality of pre-set information comprises fingerprint template of the user, user account details and the unique authorization code associated with the user.

According to one embodiment herein, the method of activating the card for the financial transaction comprises providing a fingerprint template of the user through a biometric sensor, performing a local authentication by verifying the extracted fingerprint template with a pre-stored fingerprint template in the payment card and activating the card for a pre-determined time if the fingerprint template matches with the pre-stored fingerprint template. The method further comprises deactivating payment card, sending a transaction approval message by a central server to the payment card after each successful transaction, reloading the payment card with additional amount for prepaid accounts, enhancing limits of payment cards, extending a validity period of the payment card on card expiration, displaying the extended validity period to the user, displaying the reward points associated with the payment card and enabling the user to redeem the reward points.

According to one embodiment herein, the payment card is deactivated during at least one of entering a wrong authorization code for more than a preset number of times, providing a transaction amount different than the preset amount of transaction and on expiration of a preset activation time period pre-set by the user for a specific financial transaction.

According to one embodiment herein, the payment card is blocked when the user's fingerprint template does not match with the pre-stored fingerprint template continuously for a preset number of times.

According to one embodiment herein, the method further comprises providing promotional offers for the users after reaching a sufficient frequency of transactions from a particular payment card, configuring the payment card for the promotional offers if the user is an unauthorized user, downloading the promotional offers to the card when the card is connected to a central system and storing the promotional offers in the memory. Here the method of communicating promotional offers comprises checking the authorization status of the user to send the promotional offers, downloading the promotional offer to the user device if the user is an authorized to receive promotional offers, storing the promotional offers in the memory and updating the promotional offers periodically.

According to one embodiment herein, the user defines the expense type, the establishment for charging the payment card and the type of charging according to the user preferences.

Embodiments herein further disclose a method of configuring a payment card for one or more secondary users by a primary user. The method comprises requesting a service provider to create a profile for the one or more secondary users to share the use of the payment card, providing the credentials of the one or more secondary users to the service provider, informing the primary user to authorize the one or more secondary users by the service provider, authorizing the one or more secondary user by the primary user, creating profiles for one or more secondary users, generating a unique identification number (PIN) for each secondary user and employing the unique PIN for validation of the one or more secondary user.

According to one embodiment herein, the method of processing the financial transaction for one or more secondary user comprises activating the payment card by providing a finger print of the secondary user, authenticating the user for the financial transaction by validating the unique identification number, entering the amount to be charged from the payment card by the secondary user and deducting the amount from the account of the primary user.

According to one embodiment herein, the primary card user is authorized for setting a number of iterations for the secondary user to a preset number where the iterations include the number of times the payment card is activated and defining a maximum amount to be deducted from the payment card to a preset value.

These and other aspects of the embodiments herein midi be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating a schematic view of an intelligent payment card, according to one embodiment herein.

FIG. 2 is a block diagram illustrating the components of the payment card for performing a secure financial transaction, according to one embodiment herein.

FIG. 3 is a flowchart illustrating a method of performing a secure financial transaction using the payment card, according to one embodiment herein.

FIG. 4 is a flowchart illustrating a process of authenticating a user for enabling a secure financial transaction, according to one embodiment herein.

FIG. 5 is a flow chart illustrating a method of configuring the payment card for multi-users, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled, in the art to practice the embodiments and it is to be understood that the logical, mechanical and other changes may be made without departing from the scope of the embodiments. The following detailed description is therefore not to be taken in a limiting sense.

The various embodiments herein provide an intelligent payment card for performing a secure financial transaction, The intelligent payment card comprises an exposed biometric sensor for activating the payment card and authenticating to user, a keypad as an input module for providing an input, a display screen for displaying a payment card information as well as transaction criteria, a processor unit for processing and generating desired output from inputs, a memory unit for storing a plurality of details for use in the financial transactions, a communication module for facilitating financial transactions, a power source for powering up the payment card, and a mini USB/USB port for connecting the payment card to an external device and for charging the battery.

The payment card comprises a biometric sensor for activating the payment card and authenticating a user. The biometric sensor is a fingerprint scanner/reader. The user provides a fingerprint template on the fingerprint scanner/reader provided on the payment card. The fingerprint reader comprises an electronic chip for recording the extracted fingerprint template of the user, authenticating the user and also activating the payment card. The authentication process comprises to step of verifying, the user by matching the extracted fingerprint template with a pre-stored fingerprint template in the payment card. The authentication of the user is done locally within the payment card, After a successful authentication, the payment card is activated. The user enters a unique PIN in the payment card. The entered PIN is validated against a pre-stored PIN details in the payment card. If the validation is unsuccessful, the payment card is deactivated. On successful validation of the user identity, the user is allowed to enter an amount to be charged on the payment card before handing over the payment card to a retailer. The exact amount entered in the payment card is charged to the account of the user, when the retailer swipes a card reader at the retailer end. The payment card is deactivated after each transaction.

The input module of the payment card is adapted for inputting a plurality of transaction criteria on the payment card. The plurality of transaction criteria comprises a user account details, a unique authorization code, a preset amount of transaction, a preset number of transactions, and a maximum threshold time for the transaction. The input module comprises a keypad for providing an input The keypad is at-least one of a tactile keypad, a QWERTY keypad or a touch screen keypad bearing digits, symbols, and usually a complete set of alphabetical letters.

The fingerprint scanner is provided on at-least one face of the payment card. The user places his/her finger on the fingerprint scanner of the payment card and provides a fingerprint template. The payment card performs a local authentication by verifying the extracted fingerprint template of the user with a pre-stored fingerprint template in the payment card. After a successful authentication, the payment card is activated and an On-Screen Keypad (OSK) is displayed. The user enters a unique PIN through the OSK. The entered PIN is validated against a pre-stored. PIN details in the payment card. If the validation is unsuccessful, the payment card is deactivated. On a successful validation of the user identity, the user is allowed to enter the amount to be charged on the payment card before handing over the payment card to a retailer. The exact amount entered in the payment card is charged to the user account when the retailer swipes the card reader at the retailer's end. The payment card is deactivated after each transaction.

The embodiments herein allow the authentication of the payment card to be done locally. The payment card details along with the amount are encrypted within the 10 payment card itself. Thus this data cannot be stolen or modified by Trojans on the POS terminal.

The processor unit in the payment card is adapted to perform the functionalities of comparing the input unique authorization code with a unique identification number stored within the payment card, authenticating the user, enabling the user to initiate the financial transaction on successful authentication, enabling a user to set preferences for the financial transaction, enabling a user to configure multiple user accounts for the payment card and to set usage Preferences for each user account. The processor is further adapted to deactivate the payment card after a predetermined number of mismatches between the transaction codes, the pre-stored transaction number, the preset number of transactions, the preset amount of transaction, and deactivate the card after a predetermined time.

The display screen of the payment card is adapted for displaying the payment card information as well as transaction criteria. The display screen shows the transaction logs and other information relating to the user and the transactions.

The memory unit is adapted for storing a plurality of details for use in the financial transactions. The memory unit of the payment card records the number of transactions, a time stamp, an amount of transaction, payment terminal ID, a location of a transaction based on GPS and IP address and location of the payment terminal. Upon requesting the transaction logs, the payment card displays the transaction logs on the display screen. This history can also be used for repudiation of false or fraudulent charges on the card.

The communication module of the payment cared comprises at least one of a USB port, a Bluetooth Infrared or Near Field Communication (NFC) for facilitating financial transactions.

The payment card comprises a power source such as a dry cell rechargeable battery and a photovoltaic source for powering up the payment card.

The payment card also comprises a mini USB/USB port for connecting the payment card to an external device for performing, certain operations and for charging the battery. The external device is at-least one of a mobile device, a desktop computer, a laptop, a tablet etc. Also, the stored transaction logs in the memory unit of the payment card are displayed on the external device by connecting the payment card to the external device through the mini USB/USB port.

According to the embodiments herein, an application is installed in a general purpose machine to perform the payment transactions. The general purpose machine includes a RFID based NFC sensor for reading NFC enabled payment cards. The application installed in the general purpose machine performs the secure payment transactions. The general purpose machine is any one of a desktop computer, a mobile device, a laptop, a tablet etc.

Here the payment card is one of a credit card, a debit card, a NFC card, an EMV card and the like. The payment card is also tamperproof and is limited by defence.

According to the embodiments herein, the method of performing a secure financial transaction using the payment card comprises of programming the payment card with a plurality of pre-set user information, verifying the authenticity of the user, activating the payment card on successful authentication of the user, inputting an unique authorization code by the user, validating the user for the financial transaction by comparing the input unique authorization code with a unique identification number stored within the payment card, defining, a maximum threshold of an amount to be charged on the payment card on successful validation, and deducting the preset amount from the card at a retailer end.

The method of verifying the authenticity of the user and activating the payment card for financial transactions comprises providing a fingerprint template of the user through a biometric sensor, performing a local authentication by verifying the extracted fingerprint template with a pre-stored fingerprint template in the payment card, and activating the payment card for a pre-determined time if the fingerprint template matches with the pre-stored fingerprint template.

The card is activated only for a preset period of time set by the user. Before handing over the payment card to the retailer, the user presets the activation time period in the payment card. Once the preset time is expired, the payment card is automatically deactivated. Further, the payment card is blocked automatically if the user's fingerprint template does not match with the pre-stored fingerprint template continuously for a preset number of times (for example: three times), if the user enters wrong authorization code or PIN continuously for more than a preset number of times (for example: more than three times), if the user provides a transaction amount different then the preset amount of transaction, and during expiry of a preset activation time period pre-set by the user for a specific financial transaction.

After each successful transaction, a transaction approval message is transmitted by the backend server and is directly displayed on the payment card. This eliminates the need for separate notification like short message service (SMS).

According to one embodiment herein, the payment card is configured for multi-users. The payment card is accessed by multi-users based on a permission of a primary card user. The method of configuring the payment card for a secondary user comprises the steps of: requesting a service provider to create a profile for one or more secondary users to share the use of the payment card of the primary user; providing the credentials like tame, address, fingerprint template, etc of the one or more secondary users to the service provider, informing the primary card user to authorize the one or more secondary users by the primary user; authorizing the one or more secondary user by the primary card user; creating profiles for one or more secondary users; generating a unique personal identification number (PIN) for each secondary user; and employing the unique PIN for validating the one or more secondary user. Alternatively, the PIN of the primary card user is also used for validating the second user. The payment card is connected to an external device through the mini USB/USB port. The external device is at-least one of a mobile device, a desktop computer, a laptop, a tablet etc. The primary card user creates a profile for the second user or alternate user by accepting the credentials of a second user, like name, address, fingerprint template, etc with the help of the external device. The external device is connected to the interface of a service provider. After a successful creation of the user profile, the second user is allowed to access the payment card of the primary user. The primary card user also generates a unique personal identification number (PIN) for the second user. The unique PIN is used for validating the second user. Alternatively, the PIN of the primary card user is also used for validating the second user.

The method of processing the financial transaction for one or more secondary user comprises of activating the payment card by providing a fingerprint of the secondary user, authenticating the secondary user for the financial transaction by validating the unique identification number provided as an input by the secondary user on the payment card, entering the amount to be charged from the payment card by the secondary user; and deducting the amount from the account of the primary user.

The primary card user is authorized to provide a preset number of iterations for the secondary user. The iterations here include a number of times the payment card is activated. The memory unit of the payment card records number of times the payment card is activated and stores the information. The card is deactivated, when the number of transactions done with the payment card exceeds the preset limit. The payment card remains deactivated even when the fingerprint reader recognizes the fingerprint template of the secondary user. The primary card user is further authorized to fix a maximum amount to be deducted from the payment card to a preset value before handing over the payment card to the secondary user. For example, when the primary card user presets the maximum amount to be one thousand rupees, the second user is allowed to perform a transaction within a range of or equal to one thousand rupees. If the transaction amount exceeds one thousand rupees, the payment card is automatically deactivated.

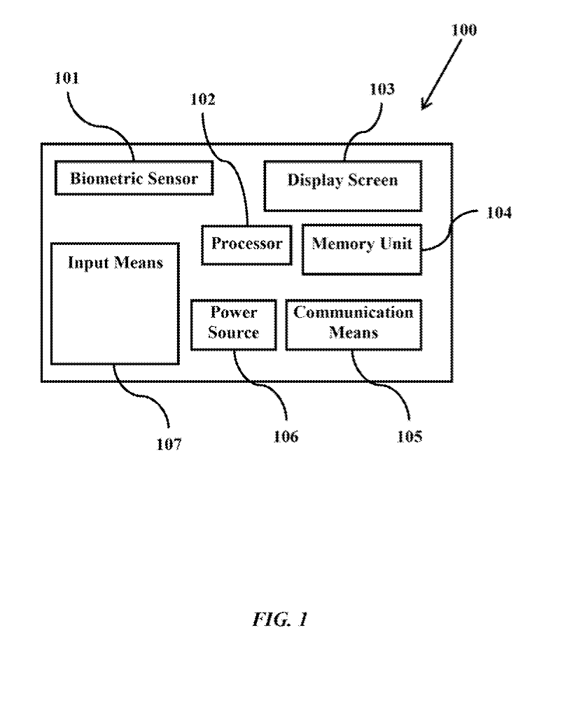

FIG. 1 is a block diagram illustrating a schematic view of an intelligent payment card, according to one embodiment herein. The intelligent payment card 100 comprises a biometric sensor 101 for authenticating the user and activating the payment card 100, a processor 102 unit for processing and generating desired output from inputs, a display screen 103 for displaying the payment card 100 information as well as transaction criteria, a memory unit 104 for storing a plurality of details for use in the financial transactions, a communication module 105 for facilitating financial transactions, a power source 106 for powering up the payment card 100 and input module 107 for providing an input to the payment card 100. The biometric sensor 101 is at least one of a finger print reader/scanner, a voice biometric sensor, an iris scanner, palm scanner or the like. The input module 107 includes at least one of a key pad, a touch pad and the like.

The processor 102 is adapted to authenticate the user by comparing the input unique authorization code with the unique identification number stored within the payment card, enable the user to initiate the financial transaction on successful authentication, enable the user to set preferences for the financial transaction. The processor 102 also enables to configure multiple user accounts to a single payment card 100 and to set usage preferences for each user account. The processor 102 is further adapted to deactivate the payment card 100 after a predetermined number of mismatches between the transaction codes, the pre-stored transaction number, the preset number of transactions, the preset amount of transaction and deactivate the card after a predetermined time.

The payment card 100 is one of a credit card, a debit card, a NFC card, an EMV card and the like. The payment card 100 is also tamperproof and is limited by defence.

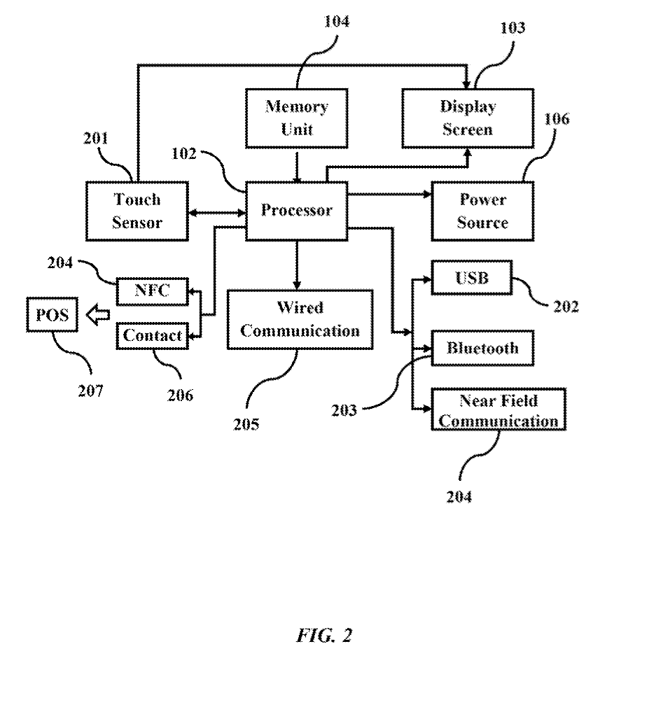

FIG. 2 is a block diagram illustrating the components of the payment card for performing a secure financial transaction, according to one embodiment herein. The intelligent payment card 100 comprises a biometric sensor. The biometric sensor is a fingerprint scanner/reader includes a touch sensor 201 for sensing and reading a fingerprint template and an electronic chip for recording the extracted fingerprint template of a user. The recorded fingerprint template is then sent to a processor 102 which matches the recorded fingerprint template with a pre-stored fingerprint template in the memory unit 104 of the payment card 100. If the fingerprint templates match each other, the processor verifies the user and activates the payment card. The user inputs the unique authorization code or PIN through the input module. The unique authorization code or PIN is also matched with a unique identification number by the processor 102. If the match is found, then the payment card 100 is ready for financial transactions.

The display screen 103 provided m the scanner displays the payment card information as well as transaction criteria, such as transaction logs and other information relating to the user and the transactions.

The payment card 100 further comprises a mini USB/USB port 202 provided at one side of the payment card 100 for configuring the payment card 100 to multi-users. The payment card 100 is connected to the external device for configuring the payment card 100 for multi-users. The mini USB/USB port 202 is also used for charging the battery or power source.

The memory unit 104 records the number of transactions, a time stamp, a location of a transaction, an amount of transaction, payment terminal ID, a location of a transaction based on GPS and IP address, location of the payment terminal, etc. Upon a request, the payment card 100 displays the transaction logs on the display screen 101 thereby providing a ready statement. Also, the stored transaction logs are displayed on the external device by connecting the payment card 100 to the external device through the mini USB/USB port 202. This history can also be used for repudiation of false or fraudulent charges on the payment card 100.

The communication module for facilitating financial transactions comprises both wired communication 204 as well as wireless communication module such as a mini USB/USB port 202, a Bluetooth 203, Infrared or Near Field Communication (NFC) 204.

The processor enables the user to process the payments and financial transactions at the Point of Sale (POS) 207 through Near Field Communication NFC 203 and direct contact 206 of the payment card 100 to a card reader by swiping or tapping the card to the card reader at a retailers end.

Further the processor enables a primary user of the payment card to set the number of iterations for the one or more secondary users to a preset number. The iterations here include the number of times the payment card 100 is activated. The primary card user can also set a maximum amount to be deducted from the payment card to a preset value.

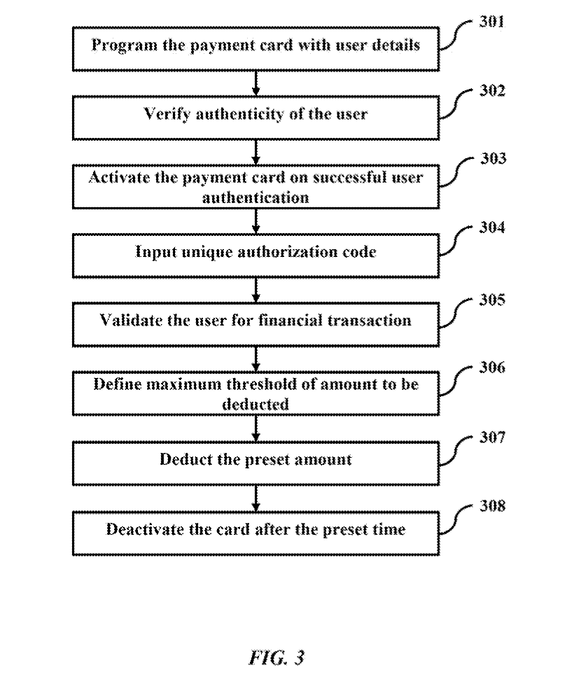

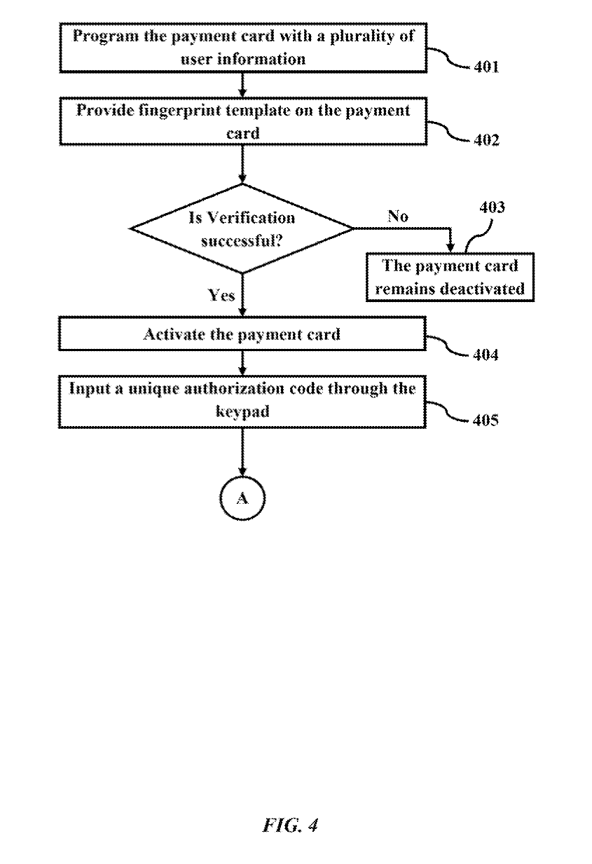

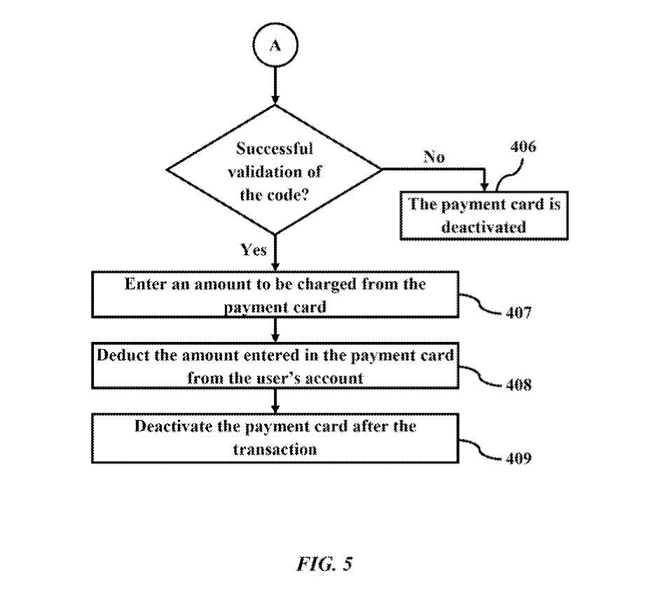

FIG. 3 is a flowchart illustrating a method of performing a secure financial transaction using the payment card, according to one embodiment herein. The method of performing a secure financial transaction comprises of programming the payment card with a plurality of pre-set user information and details (301), verifying the authenticity of the user (302), activating the payment card on successful authentication of the user (303), inputting an unique authorization code or PIN by the user (304), validating the user for financial transactions by comparing the input unique authorization code with a unique identification number stored within the payment card (305), defining a maximum threshold of an amount to be charged on the payment card on successful validation (306), deducting the preset amount from the card at a retailer end (307) and deactivating the payment card after a preset time (308).

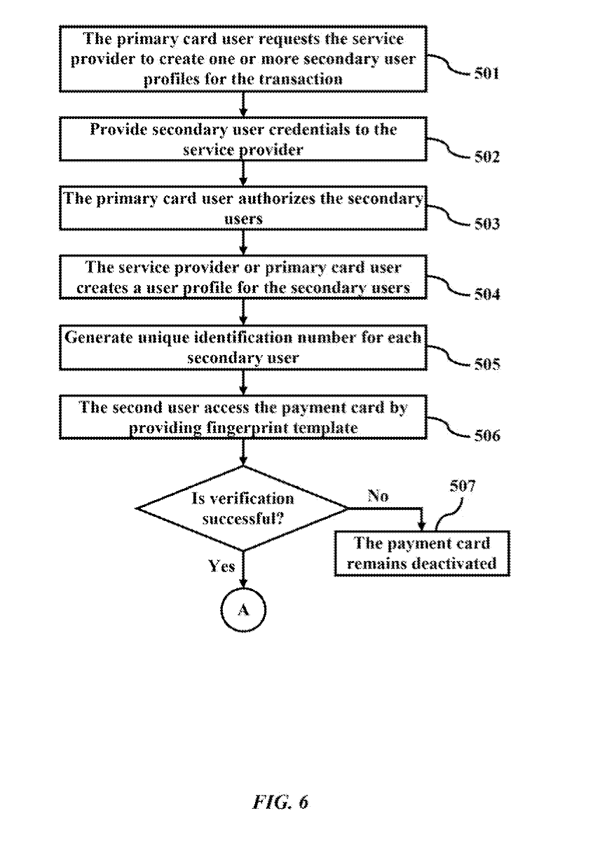

FIG. 4 is a flowchart illustrating a process of authenticating a user for enabling a secure financial transaction, according to one embodiment herein. The payment card is programmed with a plurality of pre-set user information and details which comprises fingerprint template of the user, user account details, and the unique authorization code or PIN associated with the user (401). The user provides a fingerprint template through the fingerprint scanner on the payment card for authentication (402). The fingerprint scanner includes a touch sensor and an electronic chip for recording the extracted fingerprint template of the user, authenticating the user and activating the payment card. The authentication of the user is done locally within the payment card. If the fingerprint template does not match with the pre-stored fingerprint template i.e. the verification is unsuccessful, then the payment card remains deactivated (403). If the fingerprint template matches with the pre-stored fingerprint template i.e. the verification is successful, then the payment card is activated (404). The user enters a unique authorization code or PIN in the payment card (405). The entered PIN is validated against a pre-stored PIN details in the payment card. If the validation is unsuccessful the payment card is deactivated (406). On a successful validation of the user identity, the user is allowed to enter an amount to be charged on the payment card before handing over the payment card to a retailer (407). The exact amount entered in the payment card is then charged from the user's account when the retailer swipes a card reader at the retailer end (408). The payment card is deactivated after each transaction (409).

According to one embodiment herein, a fingerprint scanner is provided on at-least one face of the payment card. The user places his/her finger on the fingerprint scanner of the payment card to provide a fingerprint template. The payment card performs a local authentication by matching the fingerprint template of the user with a pre-stored fingerprint template in the payment card. After a successful authentication, the payment card is activated and an On-Screen Keypad (OSK) is displayed. The user enters a unique PIN through the OSK displayed on the payment card. The entered PIN is validated against a pre-stored PIN details in the payment card. If the validation is unsuccessful, the payment card is deactivated. On a successful validation of the user identity, the user is allowed to enter the amount to be charged on the payment card before handing over the payment card handing to the retailer. The exact amount entered in the payment card is charged to the user account when the retailer swipes the card reader at the retailer end. The payment card is deactivated after each transaction.

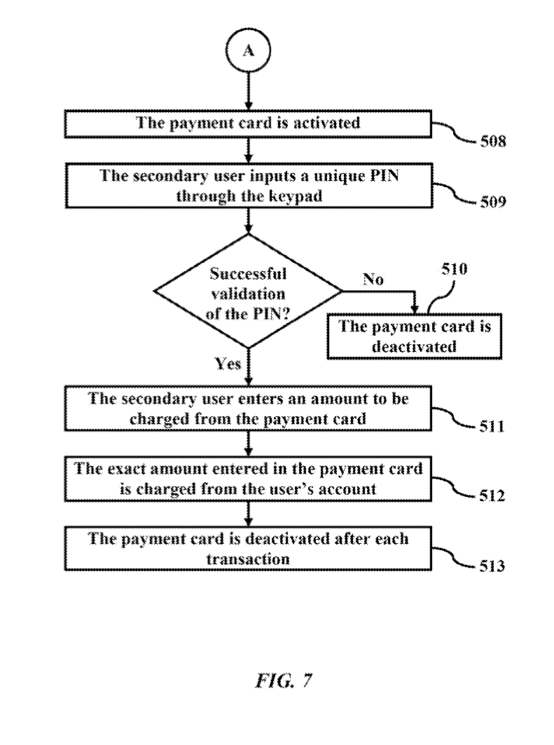

FIG. 5 is a flow chart illustrating a method of configuring the payment card for multi-users, according to one embodiment herein. The payment card is accessed by multi-users based on a permission or approval of a primary card user. The primary card user requests the service provider for creating a profile for one or more secondary users to share the use of the payment card for transactions (501), The secondary users provide their credentials like name, address, fingerprint template, etc to the service provider (502). The service provider informs the primary card user to authorize the secondary users. The primary card user authorizes the secondary users (503). The service provider or the primary card user then creates the user profiles for the secondary users (504). The service provider or the primary card user also generates a unique authorization or identification number or PIN for each secondary user (505). The unique PIN of each secondary user is used for validating the respective secondary users. Alternatively, the PIN of the primary card user is also used for validating the one or more secondary users.

According to one embodiment herein, a mini USB/USB port is provided at one side of the payment card to configure the payment card for multi-users. The payment card is connected to an external device through the mini USB/USB port. The external device is at-least one of a mobile device, a desktop computer, a laptop, a tablet etc. The primary card user creates a profile for the second user or alternate user by accepting the credentials of the second user with the help of the external device. The credentials include a name, an address, fingerprint template. etc. The external device is connected to the interface of a service provider. After a successful creation of the user profile, the second user is allowed to access the payment card of the primary user.

One or more secondary user provides a fingerprint template on the fingerprint scanner for accessing the payment card (506). The authentication of the one or more secondary user is done locally within the payment card. If the extracted fingerprint template does not match with the pre-stored fingerprint template i.e. the verification is unsuccessful, then the payment card remains deactivated (507). If the fingerprint template matches with the pre-stored fingerprint template i.e. the verification successful, then the payment card is activated (508). One or more secondary user enters a unique PIN in the payment card through the keypad or an On-Screen Keyboard (OSK) (509). The entered PIN is validated against a pre-stored PIN details in the payment card. If the validation is unsuccessful, the payment card is deactivated (510). On a successful validation of the second user identity, the second user is allowed to enter an amount to be charged on the payment card before handing over the payment card to a retailer (511). The exact amount entered in the payment card is charged from the primary user's account when the retailer swipes a card reader at the retailer end (512). The payment card is deactivated after each transaction (513).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the disclosure with modifications. However, all such modifications are deemed to be within the scope of the claims.

It is also to he understood that the following claims are intended to cover all of the generic and specific features of the embodiments described herein and all the statements of the scope of the embodiments which as a matter of language might be said to fail there between.

What is claimed is:

1. A payment card for a secure financial transaction comprises;
a biometric sensor for activating the payment card;
an input means for inputting a plurality of transaction details on the payment card;
where the plurality of transaction details comprises a user account details, a unique authorization code, a preset amount of transaction, a preset number of transactions and a maximum threshold time for the transaction;
a memory unit for storing the plurality of details for use in the financial transaction;
a processor unit adapted to:
compare the input unique authorization code with a unique identification number stored within the payment card;
authenticate the user;
enable the user to initiate the financial transaction on successful authentication,
enable a user to set preferences for the financial transaction;
enable a user to configure multiple user accounts for the payment card and to set usage preferences for each user account;
a display screen to show the transaction logs; and
a communication means for communicating one or more transaction details to a transaction terminal to facilitate the financial transaction.

2. The payment card of claim 1, wherein the biometric sensor is a fingerprint reader, wherein the fingerprint reader comprises an electronic chip for recording an extracted fingerprint template of the user, activating the payment card and authenticating the user.

3. The payment card of claim 1, wherein the input means is at-least one of a tactile keypad, a QWERTY keypad and a touch screen keypad.

4. The payment card of claim 1, wherein the communication means comprises at least one of a USB port, a Bluetooth, Infrared or Near Field communication.

5. The payment card of claim 1, wherein the memory unit records the number of transactions, a time stamp, an amount of transaction, payment terminal ID, a location of a transaction based on GPS and IP address and location of the payment terminal.

6. The payment card of claim 1, further comprises a power source for powering up the payment card, where the power source is at least one of a dry cell, rechargeable battery and a photovoltaic source.

7. The payment card of claim 1, wherein the payment card is one of a credit card, a debit card, a NFC card and an EMV card.

8. The payment card of claim 1, wherein the payment card is tamperproof and limited by defence.

9. The payment card of claim 1, wherein the processor is further adapted to deactivate the payment card after a predetermined number of mismatches between the transaction code, the pre-stored transaction number, the preset number of transactions, the preset amount of transaction, deactivate the card after a predetermined time, charge the payment card with money, track the reward points of the card, display the reward points to the user and enables the user to redeem the reward points.

10. The payment card of claim 1, is configured by at least one of a user or a backend server.

11. The payment card of claim 1, wherein the merchant configures the card type.

12. A method of performing a secure financial transaction using a payment card, the method comprises:
programming the payment card with a plurality of pre-set user information;
verifying the authenticity of the user;
activating the payment card on successful authentication of the user;
inputting an unique authorization code by the user;
validating the user for the financial transaction by comparing the input unique authorization code with a unique identification number stored within the payment card;
defining a maximum threshold of an amount to be charged on the payment card on successful validation; and
deducting the preset amount from the card at a retailer end;
wherein the plurality of pre-set information comprises fingerprint template of the user, user account details and the unique authorization code associated with the user.

13. The method of claim 12, wherein the activating the card for the financial transaction comprises:
providing a fingerprint template of the user through a biometric sensor;
performing a local authentication by verifying the extracted fingerprint template with a pre-stored fingerprint template in the payment card; and
activating the card for a pre-determined time if the fingerprint template matches with the pre-stored fingerprint template.

14. The method of claim 12, wherein the payment card is blocked when the user's fingerprint template does not match with the pre-stored fingerprint template continuously for a preset number of times.

15. The method of claim 12, further comprises deactivating the payment card during at least one of:
entering a wrong authorization code for more than a preset number of times;
providing a transaction amount different than the preset amount of transaction; and
expiring a preset activation time period pre-set by the user for a specific financial transaction.

16. The method of claim 12, further comprises sending a transaction approval message by a central server to the payment card after each successful transaction.

17. The method of claim 12, further comprises:
reloading the payment card with additional amount for prepaid accounts;
enhancing limits of payment cards;
extending a validity period of the payment card on card expiration,
displaying the extended validity period to the user;
displaying the reward points associated with the payment card; and
enabling the user to redeem the reward points.

18. The method of claim 12, further comprises providing promotional offers for the users after reaching a sufficient frequency of transactions from a particular payment card, wherein communicating promotional offers comprises:
checking the authorization status of the user to send the promotional offers;
downloading the promotional offer to the user device if the user is an authorized to receive promotional offers;
storing the promotional offers in the memory; and
updating the promotional offers periodically.

19. The method of claim 18 further comprises:
configuring the payment card for the promotional offers if the user is an unauthorized user;
downloading the promotional offers to the card when the card is connected to a central system; and
storing the promotional offers in the memory.

20. The method of claim 12, wherein the user defines the expense type, the establishment for charging the payment card and the type of charging according to the user preferences.

21. A method of configuring a payment card for one or more secondary users by a primary user, the method comprises:
requesting a service provider to create a profile for the one or more secondary users to share the use of the payment card;
providing the credentials of the one or more secondary users to the service provider;
informing the primary user to authorize the one or more secondary users by the service provider;
authorizing the one or more secondary user by the primary user;
creating profiles for one or more secondary users;
generating a unique identification number (PIN) for each secondary user; and
employing the unique PIN for validation of the one or more secondary user.

22. The method of claim 21, wherein processing the financial transaction for one or more secondary user comprises:
activating the payment card by providing a finger print of the secondary user;
authenticating the user for the financial transaction by validating the unique identification number;
entering the amount to be charged from the payment card by the secondary user; and
deducting the amount from the account of the primary user.

23. The method of claim 21, wherein the primary card user is authorized for:
setting a number of iterations for the secondary user to a preset number where the iterations include the number of times the payment card is activated; and
defining a maximum amount to be deducted from the payment card to a preset value.
